(19) United States
(12) Patent Application Publication
(10) Pub. No.: US 2011/0240403 A1
(43) Pub. Date: Oct. 6, 2011

(54) Lifeline Connector for Use with Self-Retracting Lifeline with Disconnectable Lifeline

(75) Inventor: Vincent G. Meillet, Cannes la Bocca (FR)

(73) Assignee: D B Industries, Inc.

(21) Appl. No.: 12/751,353

(22) Filed: Mar. 31, 2010

(51) Int. Cl. A62B 1/16; B23P 6/00

(52) U.S. Cl. 182/3; 29/402.08

(57) ABSTRACT

A lifeline connector assembly for releasably interconnecting a first portion and a second portion of a lifeline, the first portion including a first distal end to which a first stop is operatively connected, the second portion including a second distal end to which a second stop is operatively connected, comprises a first stop operatively connected to the first distal end, a second stop operatively connected to the second distal end, and a receiving member operatively connected to the second stop and configured and arranged to receive at least a portion of the first stop thereby interconnecting the first portion and the second portion.

### FIELD OF THE INVENTION

The present invention relates to a lifeline connector for use with a self-retracting lifeline with a disconnectable lifeline.

### BACKGROUND

Various occupations place people in precarious positions at relatively dangerous heights thereby creating a need for fall arrest, fall protection, and rescue equipment. Among other things, such equipment usually includes a lifeline interconnected between a support structure and a person working in proximity to the support structure. The lifeline is typically secured to a full-body safety harness worn by the user.

Self-retracting lifelines are commonly used by workers performing tasks during which there is a risk a fall may occur. A self-retracting lifeline generally includes a housing containing a drum around which a lifeline such as cable, rope, or webbing is wound. The drum is spring biased to pay out the lifeline as tension pulling the lifeline is applied and to retract the lifeline that has been unwound from the drum as the tension on the lifeline is reduced or released. The housing also includes a brake assembly for stopping rotation of the drum when the lifeline suddenly unwinds from the drum at a rate greater than a predetermined maximum angular velocity.

A self-retracting lifeline is typically connected to a support structure within the vicinity the worker is performing the task, and an end of the lifeline is typically connected to a safety harness worn by the worker. The lifeline is easily drawn out of the self-retracting lifeline housing as the worker moves away from the device, and the lifeline is automatically drawn back into the housing as the worker moves toward the device. Should a fall occur, the brake assembly within the device is automatically engaged by a centrifugal clutch assembly, which gradually and quickly stops the worker's fall by gradually and quickly stopping the rotation of the drum. As the rotation of the drum is stopped, additional lifeline is prevented from being paid out of the housing to stop the fall of the worker.

A self-retracting lifeline could also include a retrieval assembly, which retracts or pays out the lifeline of the self-retracting lifeline, to raise or lower the worker to a safe location should a fall occur.

Through use, the lifeline could become worn, and the integrity of the self-retracting lifeline could become compromised therefore compelling replacement of the lifeline to optimize safety. Some self-retracting lifelines require that the entire device be sent in for repair to replace the lifeline while some self-retracting lifelines are “field-replaceable” because the lifelines can be replaced by the worker.

For the reasons stated above and for other reasons stated below, which will become apparent to those skilled in the art upon reading and understanding the present specification, there is a need in the art for a self-retracting lifeline with a disconnectable lifeline.

### SUMMARY

The above-mentioned problems associated with prior devices are addressed by embodiments of the present invention and will be understood by reading and understanding the present specification. The following summary is made by way of example and not by way of limitation. It is merely provided to aid the reader in understanding some of the aspects of the invention.

In one embodiment, a lifeline connector assembly for releasably interconnecting a first portion and a second portion of a lifeline, the first portion including a first distal end to which a first stop is operatively connected, the second portion including a second distal end to which a second stop is operatively connected, comprises a first stop operatively connected to the first distal end, a second stop operatively connected to the second distal end, and a receiving member operatively connected to the second stop and configured and arranged to receive at least a portion of the first stop thereby interconnecting the first portion and the second portion.

In one embodiment, a lifeline assembly comprises a lifeline and a connector. The lifeline includes a first lifeline portion and a second lifeline portion. The first lifeline portion includes a first distal end to which a first stop is operatively connected, and the second lifeline portion includes a second distal end to which a second stop is operatively connected. The connector includes a first connector portion and a second connector portion. The first connector portion and the second connector portion are configured and arranged to receive and operatively connect the first stop and the second stop.

In one embodiment method of replacing a portion of a lifeline, the lifeline includes a first portion and a second portion releasably connectable with a connector, the first portion is operatively connected to a drum rotatable within a housing of a self-retracting lifeline, and the second portion is replaceable. The lifeline is paid out to expose the connector, and the at least one of the first portion and the second portion is disconnected from the connector thereby disconnecting the second portion from the first portion. A replacement second portion is obtained, and the replacement second portion is connected to the first portion with the connector.

### BRIEF DESCRIPTION OF THE DRAWINGS

The present invention can be more easily understood, and further advantages and uses thereof can be more readily apparent, when considered in view of the detailed description and the following Figures in which:

FIG. 1 is a front view of a lifeline connector constructed in accordance with the principles of the present invention;

FIG. 2 is a perspective view of the lifeline connector shown in FIG. 1;

FIG. 3 is a cross-section view of the lifeline connector shown in FIG. 1;

FIG. 4 is a perspective view of another embodiment lifeline connector constructed in accordance with the principles of the present invention;

FIG. 5 is a partial exploded perspective view of the lifeline connector shown in FIG. 4 with a portion of the lifeline disconnected;

FIG. 6 is a front view of the lifeline connector shown in FIG. 4;

FIG. 7 is a cross-section view of the lifeline connector shown in FIG. 6 rotated ninety degrees;

FIG. 8 is a front perspective view of another embodiment lifeline connector constructed in accordance with the principles of the present invention;

FIG. 9 is a partial exploded front perspective view of the lifeline connector shown in FIG. 8 with a portion of the lifeline disconnected;

FIG. 10 is a rear perspective view of the lifeline connector shown in FIG. 8;

FIG. 11 is a side perspective view of the lifeline connector shown in FIG. 8;

FIG. 12 is a cross-section view of the lifeline connector shown in FIG. 11 rotated ninety degrees;

FIG. 13 is a front perspective view of another embodiment lifeline connector constructed in accordance with the principles of the present invention;

FIG. 14 is a partial exploded front perspective view of the lifeline connector shown in FIG. 13;

FIG. 15 is a cross-section view of the lifeline connector shown in FIG. 13;

FIG. 16 is a perspective view of another embodiment lifeline connector constructed in accordance with the principles of the present invention;

FIG. 17 is a partial exploded perspective view of the lifeline connector shown in FIG. 16;

FIG. 18 is a cross-section view of the lifeline connector shown in FIG. 16 rotated forty-five degrees;

FIG. 19 is a perspective view of another embodiment lifeline connector constructed in accordance with the principles of the present invention;

FIG. 20 is a partial exploded perspective view of the lifeline connector shown in FIG. 19;

FIG. 21 is a side view of the lifeline connector shown in FIG. 19;

FIG. 22 is a cross-section view of the lifeline connector shown in FIG. 21 rotated ninety degrees;

FIG. 23 is a perspective view of another embodiment lifeline connector constructed in accordance with the principles of the present invention;

FIG. 24 is a partial exploded perspective view of the lifeline connector shown in FIG. 23;

FIG. 25 is a side view of the lifeline connector shown in FIG. 23;

FIG. 26 is a cross-section view of the lifeline connector shown in FIG. 25 rotated ninety degrees;

FIG. 27 is a perspective view of another embodiment lifeline connector constructed in accordance with the principles of the present invention;

FIG. 28 is a partial exploded perspective view of the lifeline connector shown in FIG. 27;

FIG. 29 is a cross-section view of the lifeline connector shown in FIG. 27 rotated forty-five degrees;

FIG. 30 is a perspective view of another embodiment lifeline connector constructed in accordance with the principles of the present invention shown wound about a drum of a self-retracting lifeline;

FIG. 31 is an exploded perspective view of the lifeline connector shown in FIG. 30;

FIG. 32 is a side view of a self-retracting lifeline; and

FIG. 33 is a perspective view of the self-retracting lifeline shown in FIG. 32 with a first side of the housing removed.

In accordance with common practice, the various described features are not drawn to scale but are drawn to emphasize specific features relevant to the present invention. Reference characters denote like elements throughout the Figures and the text.

### DETAILED DESCRIPTION OF A PREFERRED EMBODIMENT

In the following detailed description, reference is made to the accompanying drawings, which form a part hereof, and in which is shown by way of illustration embodiments in which the inventions may be practiced. These embodiments are described in sufficient detail to enable those skilled in the art to practice the invention, and it is to be understood that other embodiments may be utilized and mechanical changes may be made without departing from the spirit and scope of the present invention. The following detailed description is, therefore, not to be taken in a limiting sense, and the scope of the present invention is defined only by the claims and equivalents thereof.

Lifeline connectors constructed in accordance with the principles of the present invention are designated by the numerals 100, 200, 300, 400, 500, 600, 700, 800, and 900 in the drawings.

Although the connections and disconnections of the lifeline connectors are being described relative to the orientations illustrated in the drawings, it is recognized that the descriptions do not limit the invention to these orientations and other orientations are possible.

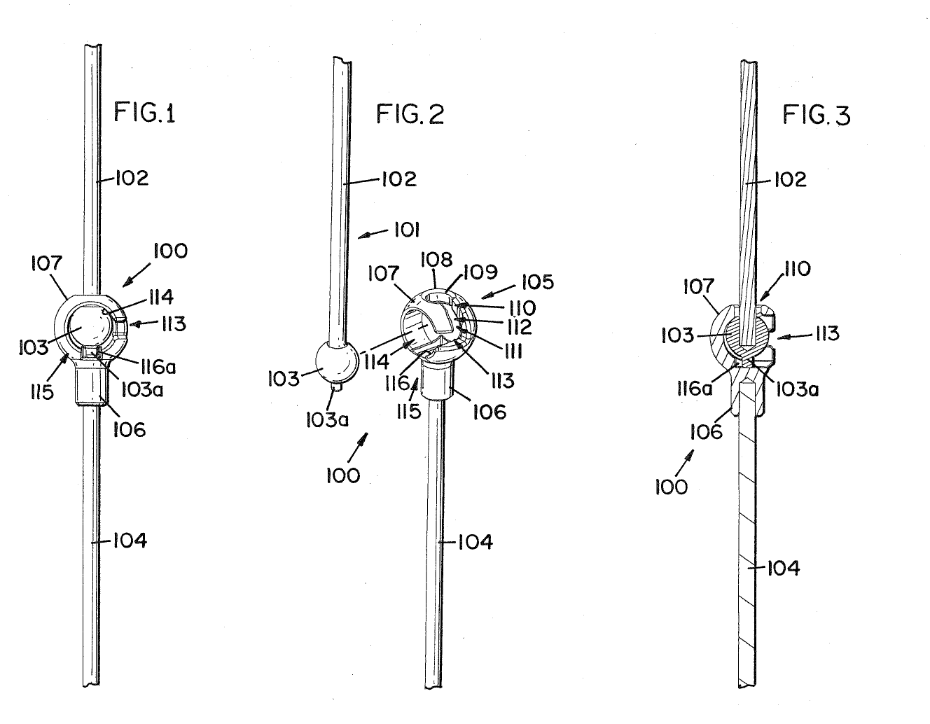

The lifeline connector 100 connects a first portion 102 and a second portion 104 of a lifeline 101. The lifeline connector 100 is shown in FIGS. 1-3. Although the lifeline 101 is shown as a cable, it is recognized that the lifeline could be a cable, a rope, webbing, or any other suitable lifeline. The lifeline connector 100 includes a stop 103 and a receiving member 105. The first portion 102 includes the stop 103 proximate its distal end, and the stop 103 includes a protrusion 103a opposite the distal end. The stop 103 is shown as being round, but any suitable shape could be used. The second portion 104 includes a stop 106 and the receiving member 105 proximate its distal end. The stop 106 receives the distal end of the second portion 104, and the receiving member 105 extends outward therefrom. The receiving member 105 is configured and arranged to receive the stop 103 of the first portion 102 thereby releasably connecting the first portion 102 and the second portion 104.

The receiving member 105 includes a spherical, hollow body 107 having a top 108 and a bottom 115. The top 108 includes an aperture 109 with a slot 110 in communication with a pathway 111 extending from proximate the top 108 to proximate the bottom 115. The pathway 111 includes an upper section 112 extending from proximate the slot 110 downward and a side section 113 extending sideways to a lower section 114 proximate the bottom 115. The pathway 111 is a tortured pathway. The aperture 109, slot 110, and pathway 111 provide access to a cavity 116 within the body 107. The cavity 116 includes a receptacle 116a proximate the bottom 115 configured and arranged to receive the protrusion 103a of the stop 103. The protrusion 103a assists in keeping the stop 103 positioned within the cavity 116 and prevents the stop 103 from sliding out of the cavity 116 through the lower section 114.

Preferably, the first portion 102 is operatively connected to a drum of a self-retracting lifeline (not shown) and the distal end including the stop 103 extends out of the self-retracting lifeline housing when the lifeline 101 is at least almost completely to completely paid out from the drum. Alternatively, the second portion 104 could be operatively connected to a drum of a self-retracting lifeline (not shown) and the distal end including the stop 106 and the receiving member 105 extends out of the self-retracting lifeline housing when the lifeline 101 is at least almost completely to completely paid out from the drum. Regardless which portion of the lifeline 101 is operatively connected to a drum of a self-retracting lifeline, the other portion can be easily and quickly replaced.

For ease of reference, replacement of the second portion 104 will be described, but it is recognized that the first portion 102 could be replaced if the second portion 104 were operatively connected to the drum of the self-retracting lifeline. To disconnect the second portion 104 from the first portion 102, the first portion 102 is routed through the aperture 109, the slot 110, and the pathway 111 so that the stop 103 can be removed from the cavity 116 through the lower section 114. The first portion 102 is preferably rigid enough to assist in keeping the stop 103 from sliding out of the cavity 116 through the lower section 114 but pliable enough so that it can be routed through the above-described route.

To connect a replacement second portion to the first portion 102, the stop 103 of the replacement second portion is inserted through the lower section 114 of the pathway into the cavity 116 so that the protrusion 103a is seated in the receptacle 116a. The first portion 102 is then routed through the pathway 111, the slot 110, and into the aperture 109 so that it extends outward from the aperture 109. The first portion 102 extending through the aperture 109 and the protrusion 103a seated in the receptacle 116a assist in preventing the stop 103 from sliding out of the cavity 116 through the lower section 114.

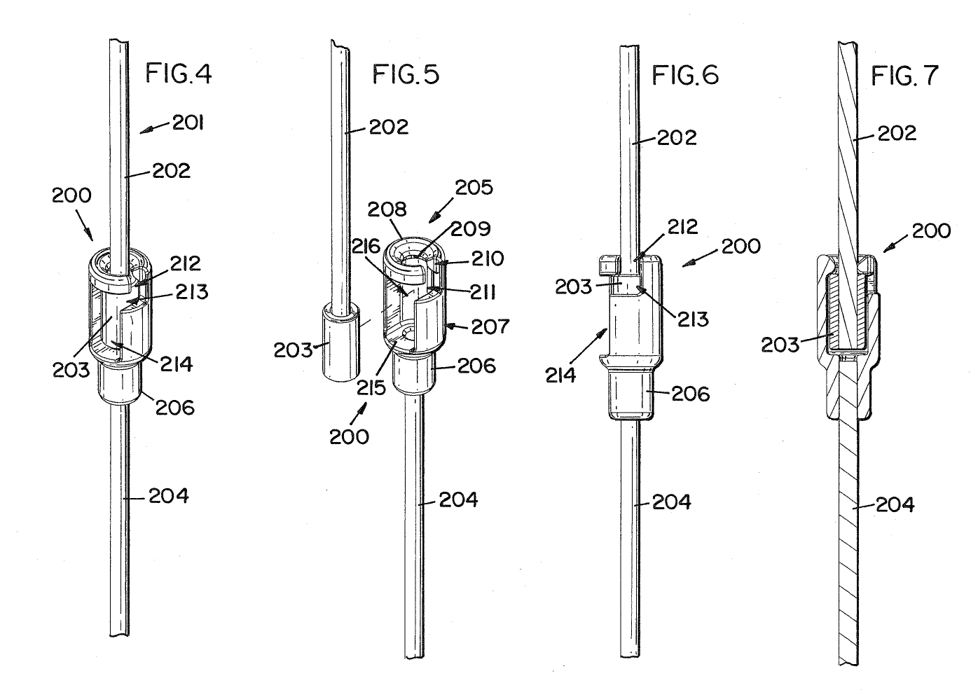

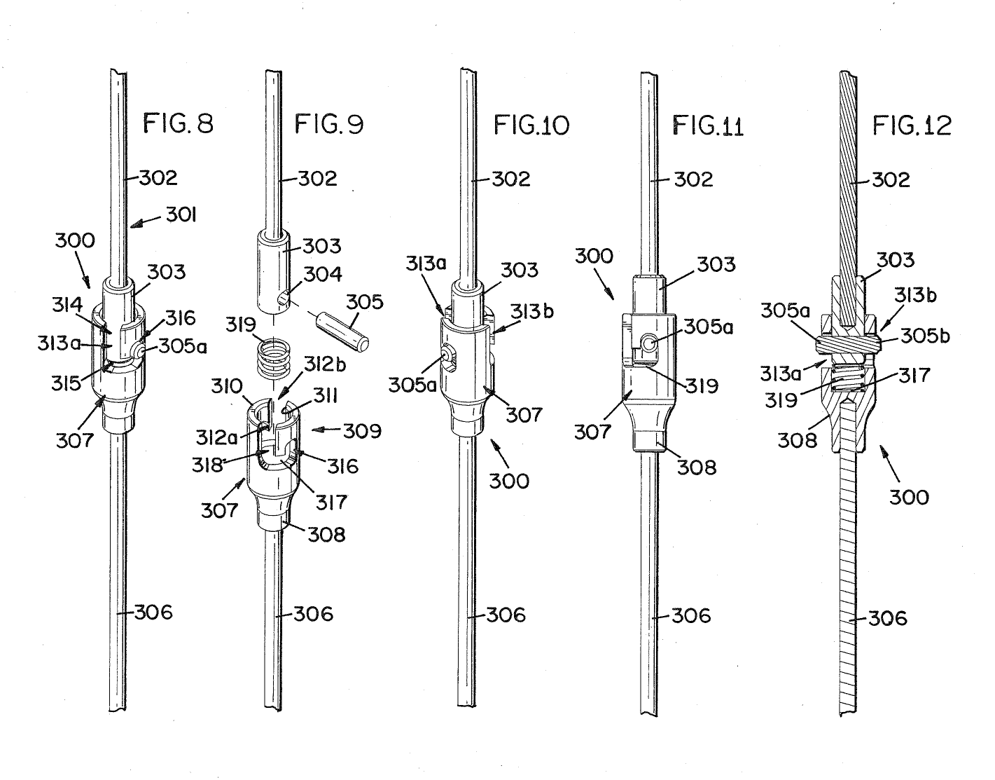

The lifeline connector 200 connects a first portion 202 and a second portion 204 of a lifeline 201. The lifeline connector 200 is shown in FIGS. 4-7. Although the lifeline 201 is shown as a cable, it is recognized that the lifeline could be a cable, a rope, webbing, or any other suitable lifeline. The lifeline connector 200 includes a stop 203 and a receiving member 205. The first portion 202 includes the stop 203 proximate its distal end, and although not shown, the stop 203 could optionally include a protrusion opposite the distal end. The stop 203 is shown as being cylindrical, but any suitable shape could be used. The second portion 204 includes a stop 206 and the receiving member 205 proximate its distal end. The stop 206 receives the distal end of the second portion 204, and the receiving member 205 extends outward therefrom. The receiving member 205 is configured and arranged to receive the stop 203 of the first portion 202 thereby releasably connecting the first portion 202 and the second portion 204.

The receiving member 205 includes a cylindrical, hollow body 207 having a top 208 and a bottom 215. The top 208 includes an aperture 209 with a slot 210 in communication with a pathway 211 extending from proximate the top 208 to proximate the bottom 215. The pathway 211 includes an upper section 212 extending from proximate the slot 210 downward and a side section 213 extending sideways to a lower section 214 proximate the bottom 215. The pathway 211 is a tortured pathway. The aperture 209, slot 210, and pathway 211 provide access to a cavity 216 within the body 207. Although not shown, the cavity 216 could optionally include a receptacle proximate the bottom 215 configured and arranged to receive the protrusion the stop 203. If used, the protrusion assists in keeping the stop 203 positioned within the cavity 216 and prevents the stop 203 from sliding out of the cavity 216 through the lower section 214.

Preferably, the first portion 202 is operatively connected to a drum of a self-retracting lifeline (not shown) and the distal end including the stop 203 extends out of the self-retracting lifeline housing when the lifeline 201 is at least almost completely to completely paid out from the drum. Alternatively, the second portion 204 could be operatively connected to a drum of a self-retracting lifeline (not shown) and the distal end including the stop 206 and the receiving member 205 extends out of the self-retracting lifeline housing when the lifeline 201 is at least almost completely to completely paid out from the drum. Regardless which portion of the lifeline 201 is operatively connected to a drum of a self-retracting lifeline, the other portion can be easily and quickly replaced.

For ease of reference, replacement of the second portion 204 will be described, but it is recognized that the first portion 202 could be replaced if the second portion 204 were operatively connected to the drum of the self-retracting lifeline. To disconnect the second portion 204 from the first portion 202, the first portion 202 is routed through the aperture 209, the slot 210, and the pathway 211 so that the stop 203 can be removed from the cavity 216 through the lower section 214. The first portion 202 is preferably rigid enough to assist in keeping the stop 203 from sliding out of the cavity 216 through the lower section 214 but pliable enough so that it can be routed through the above-described route.

To connect a replacement second portion to the first portion 202, the stop 203 of the replacement second portion is inserted through the lower section 214 of the pathway into the cavity 216, and if the protrusion and receptacle are used, the protrusion is seated in the receptacle. The first portion 202 is then routed through the pathway 211, the slot 210, and into the aperture 209 so that it extends outward from the aperture 209. The first portion 202 extending through the aperture 209 and, if the protrusion is used, the protrusion seated in the receptacle, assist in preventing the stop 203 from sliding out of the cavity 216 through the lower section 214.

The lifeline connector 300 connects a first portion 302 and a second portion 306 of a lifeline 301. The lifeline connector 300 is shown in FIGS. 8-12. Although the lifeline 301 is shown as a cable, it is recognized that the lifeline could be a cable, a rope, webbing, or any other suitable lifeline. The lifeline connector 300 includes a stop 303 and a receiving member 307. The first portion 302 includes the stop 303 proximate its distal end, and the stop 303 includes a lateral bore 304 through which a protrusion 305 extends laterally outward therefrom opposite the distal end. The protrusion 305 is preferably press fit within the bore 304 of the stop 303. The protrusion 305 could also be operatively connected with a fastener such as a screw to the stop 303 or integral with the stop 303. The protrusion 305 includes a first extension portion 305a and a second extension portion 305b, which extend outward from opposing sides of the stop 303. The stop 303 is shown as being cylindrical, but any suitable shape could be used. The second portion 306 includes a stop 308 and the receiving member 307 proximate its distal end. The stop 308 receives the distal end of the second portion 306, and the receiving member 307 extends outward therefrom. The receiving member 307 is configured and arranged to receive the stop 303 of the first portion 302 thereby releasably connecting the first portion 302 and the second portion 306.

The receiving member 307 includes a cylindrical, hollow body 309 having a top 310 and a bottom 317. The top 310 includes an aperture 311 with opposing slots 312a and 312b in communication with respective pathways 313a and 313b extending from proximate the top 310 to proximate the bottom 317. As shown in FIG. 8, pathway 313a includes an upper section 314 extending from proximate the slot 312a downward and a side section 315 extending sideways to a lower section 316 extending upward proximate the bottom 317. The pathway 313b similarly includes an upper section, a side section, and a lower section. The pathways 313a and 313b are tortured pathways. The aperture 311, slots 312a and 312b, and pathways 313a and 313b provide access to a cavity 318 within the body 309. Proximate the bottom 317, a biasing member 319 is positioned within the cavity 318.

Preferably, the first portion 302 is operatively connected to a drum of a self-retracting lifeline (not shown) and the distal end including the stop 303 extends out of the self-retracting lifeline housing when the lifeline 301 is at least almost completely to completely paid out from the drum. Alternatively, the second portion 306 could be operatively connected to a drum of a self-retracting lifeline (not shown) and the distal end including the stop 308 and the receiving member 307 extends out of the self-retracting lifeline housing when the lifeline 301 is at least almost completely to completely paid out from the drum. Regardless which portion of the lifeline 301 is operatively connected to a drum of a self-retracting lifeline, the other portion can be easily and quickly replaced.

For ease of reference, replacement of the second portion 306 will be described, but it is recognized that the first portion 302 could be replaced if the second portion 306 were operatively connected to the drum of the self-retracting lifeline. To disconnect the second portion 306 from the first portion 302, a downward force is exerted upon the first portion 302 to overcome the upward force exerted upon the stop 303 by the biasing member 319, which biases the stop 303 upward so that the extension portions 305a and 305b are positioned within the lower sections of the pathways 313a and 313b. After the extension portions 305a and 305b are moved downward proximate the side sections of the pathways 313a and 313b, the first portion 302 is then rotated so that the extension portions 305a and 305b are routed through the side sections, and then the first portion 302 is moved upward so that the extension portions 305a and 305b are routed upward through the upper sections of the pathways 313a and 313b and through the slots 312a and 312b so that the stop 303 can be removed from the cavity 318 through the top 310.

To connect a replacement second portion to the first portion 302, the stop 303 of the replacement second portion is inserted through the aperture 311 with the extension portions 305a and 305b being inserted through the respective slots 312a and 312b. The extension portions 305a and 305b are then routed through the upper sections, side sections, and lower sections of the pathways 313a and 313b. When the extension portions 305a and 305b are being routed through the upper sections, a downward force is exerted upon the first portion 302 to overcome the upward force of the biasing member 319 on the stop 303. The biasing member 319 exerts an upward force on the stop 303 so that the extension portions 305a and 305b are positioned within the lower sections of the pathways 313a and 313b to prevent the first portion 302 from being disconnected from the second portion 306.

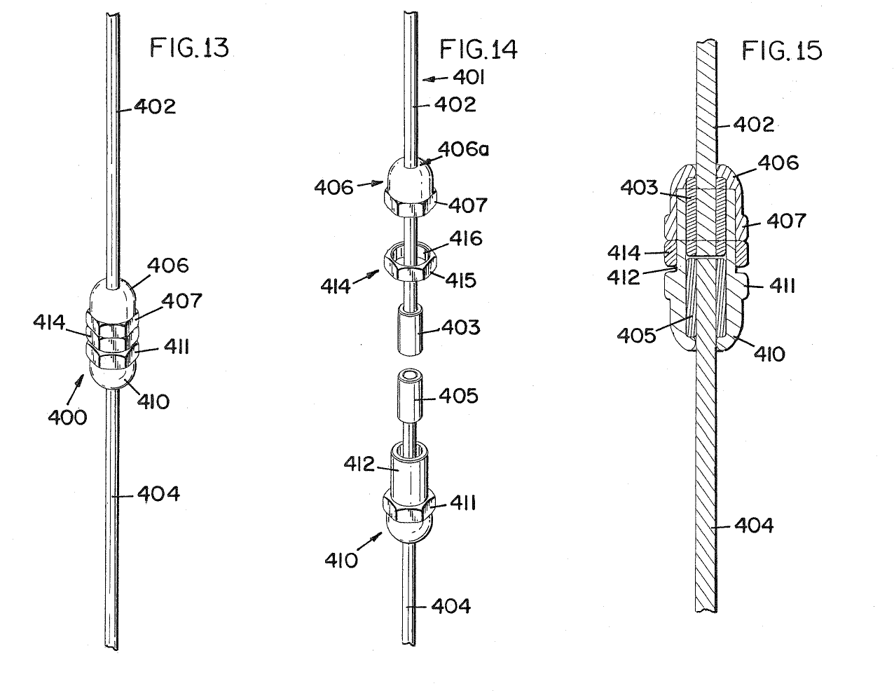

The lifeline connector 400 connects a first portion 402 and a second portion 404 of a lifeline 401. The lifeline connector 400 is shown in FIGS. 13-15. Although the lifeline 401 is shown as a cable, it is recognized that the lifeline could be a cable, a rope, webbing, or any other suitable lifeline. The first portion 402 includes a stop 403 proximate its distal end, and the second portion 404 includes a stop 405 proximate its distal end.

The lifeline connector 400 includes a first connector portion 406, a second connector portion 410, and a third connector portion 414. The first connector portion 406 is operatively connected to the first portion 402 proximate the stop 403, and the second connector portion 410 is operatively connected to the second portion 404 proximate the stop 405.

The first connector portion 406 includes a bore 406a through which the first portion 402 extends and a hexagonal flange 407 positioned proximate the stop 403. The bore 406a is configured and arranged to receive at least a portion of the stop 403. The first connector portion 406 also includes internal threads (not shown) within an inner surface forming the bore 406a proximate the hexagonal flange 407.

The second connector portion 410 includes a hexagonal flange 411, a cylindrical portion 412, and a bore (not shown) through which the second portion 404 extends. The bore extends through the hexagonal flange 411 and the cylindrical portion 412 and is configured and arranged to receive the stop 405 and could also receive a portion of the stop 403. Thus, the cylindrical portion 412 is a receiving member. The hexagonal flange 411 and the cylindrical portion 412 are positioned proximate the stop 405, and the cylindrical portion 412 includes external threads (not shown). The external threads are configured and arranged to mate with the internal threads of the first connector portion 406.

The third connector portion 414 includes a hexagonal outer surface 415 and a threaded bore 416. The threaded bore 416 is configured and arranged to mate with the external threads of the second connector 410.

To connect the first portion 402 and the second portion 404, the third connector portion 414 is threaded onto the cylindrical portion 412 of the second connector portion 410, preferably so that it contacts the hexagonal flange 411. The first connector portion 406 is then threaded onto the cylindrical portion 412 of the second connector portion 410, preferably so that it contacts the third connector portion 414. When the connector portions are connected, the stops 403 and 405 are positioned within the bores of the first and second connector portions. To tighten and secure the connector, the third connector portion 414 is threaded upward toward the first connector portion 406 to increase the tension. Alternatively, the third connector portion could be a biasing member exerting a force on the first and second connectors to increase the tension therebetween.

Regardless which portion of the lifeline 401 is operatively connected to a drum of a self-retracting lifeline, the other portion can be easily and quickly replaced. To replace a portion of the lifeline 401, the third connector portion 414 is threaded downward toward the second connector portion 410 to decrease the tension. The first connector portion 406 is then threaded off of the cylindrical portion 412 of the second connector portion 401. The first and second portions 402 and 404 are then disconnected, and a replacement portion can then be connected to the portion of the self-retracting lifeline as described above.

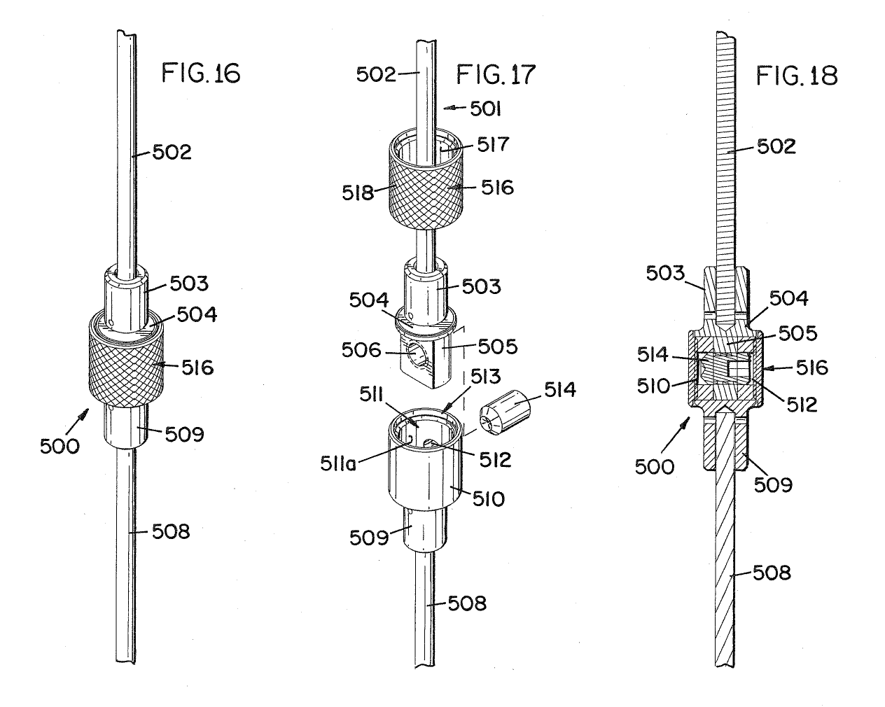

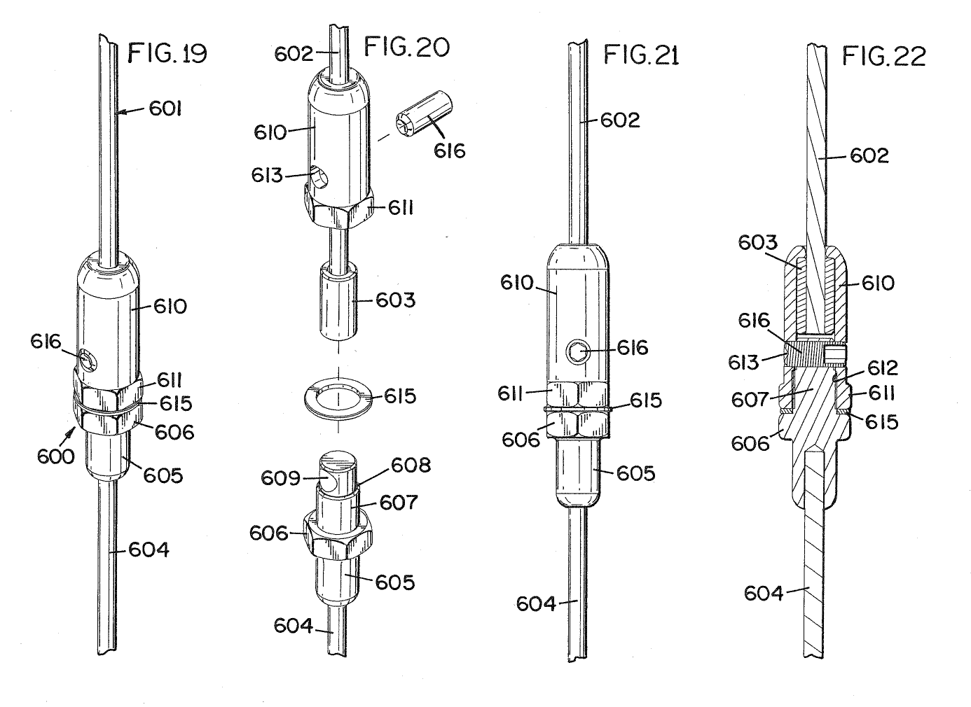

The lifeline connector 500 connects a first portion 502 and a second portion 508 of a lifeline 501. The lifeline connector 500 is shown in FIGS. 16-18. Although the lifeline 501 is shown as a cable, it is recognized that the lifeline could be a cable, a rope, webbing, or any other suitable lifeline. The first portion 502 includes a stop 503 proximate its distal end, and the second portion 508 includes a stop 509 proximate its distal end.

The stop 503 is preferably cylindrical in shape, but any suitable shape could be used. A flange 504 extends outward from the stop 503 opposite the distal end of the first portion 502, and an extension 505 extends outward from the flange 504. The extension 505 is preferably rectangular in shape with a bore 506 extending laterally through the extension 505.

The stop 509 is also preferably cylindrical in shape, but any suitable shape could be used. A cylindrical portion 510 extends outward from the stop 509 and includes an opening 511a providing access to a cavity 511. The outer surface of the cylindrical portion 510 is threaded (not shown), and a side of the cylindrical portion 510 includes an aperture 512.

The cavity 511 is configured and arranged to receive the extension 505, and the top of the cylindrical portion 510 includes a ledge 513 upon which the flange 504 rests. The aperture 512 in the cylindrical portion 510 aligns with the bore 506 of the extension 505, and a fastener such as a set screw 514 is inserted through the aperture 512 and the bore 506 to connect the extension 505 and the cylindrical portion 510. Thus, the cylindrical portion 510 is a receiving member.

A collar portion 516 is preferably cylindrical in shape and includes a threaded bore 517 and a knurled outer surface 518. The threaded bore 517 is configured and arranged to mate with the threads on the outer surface of the cylindrical portion 510. The collar portion 516 is configured and arranged to fit over the cylindrical portion 510 and prevents the set screw 514 from coming out of the aperture 512 and the bore 506.

To connect the first portion 502 and the second portion 508, the extension 505 is inserted into the cavity 511 so that the bore 506 aligns with the aperture 512 and then the set screw 514 is inserted through the aperture 512 and the bore 506. The collar portion 516 is then threaded onto the cylindrical member 510.

Regardless which portion of the lifeline 501 is operatively connected to a drum of a self-retracting lifeline, the other portion can be easily and quickly replaced. To replace a portion of the lifeline 501, the collar portion 516 is threaded off of the cylindrical member 510, the set screw 514 is removed from the bore 506 and the aperture 512, and then the extension 505 is removed from the cavity 511. A replacement portion can then be connected to the portion of the self-retracting lifeline as described above.

The lifeline connector 600 connects a first portion 602 and a second portion 604 of a lifeline 601. The lifeline connector 600 is shown in FIGS. 19-22. Although the lifeline 601 is shown as a cable, it is recognized that the lifeline could be a cable, a rope, webbing, or any other suitable lifeline. The first portion 602 includes a stop 603 proximate its distal end, and the second portion 604 includes a stop 605 proximate its distal end. The stops 603 and 605 are preferably cylindrical in shape, but any suitable shape could be used.

A hexagonal flange 606 extends outward from the stop 605 opposite the distal end of the second portion 604, and a cylindrical portion 607 extends outward from the flange 606. The cylindrical portion 607 includes a shoulder 608 proximate the middle of the cylindrical portion 607 and the diameter of the cylindrical portion 607 is wider proximate the flange 606 than proximate the top. The cylindrical portion 607 is threaded proximate the flange 606. Proximate the top of the cylindrical portion 607 is a bore 609 extending laterally therethrough. A washer 615, which is preferably made of urethane, is positioned about the cylindrical portion 607 proximate the flange 606.

A receiving member 610 is operatively connected to the first portion 602 proximate the stop 603. The receiving member 610 is preferably generally cylindrical in shape and includes a bore 612. The bore 612 is configured and arranged to receive the stop 603 and at least a portion of the cylindrical portion 607. The inner surface of the receiving member 610 forming the bore 612 is threaded to mate with the threaded portion of the cylindrical portion 607. The receiving member 610 also includes a hexagonal flange 611 proximate its distal end and a bore 613 extending laterally through the receiving member 610 proximate the hexagonal flange 611. The bore 613 aligns with the bore 609 when the receiving member 610 and the cylindrical portion 607 are connected, and a fastener such as a set screw 616 is inserted through the bores 613 and 609 to assist in preventing the receiving member 610 and the cylindrical portion 607 from becoming disconnected.

To connect the first portion 602 and the second portion 604, the washer 615 is positioned about the cylindrical portion 607 proximate the flange 606. The stop 603 is positioned within the bore 612 of the receiving member 610, and the receiving member 610 is threaded onto the cylindrical portion 607. The flanges 606 and 611 may be used to assist in threading the receiving member 610 onto the cylindrical portion 607. As the receiving member 610 is threaded onto the cylindrical portion 607, the washer 615 is compressed to provide tension. Alternatively, a spring disk could be used instead of a washer. When the bores 609 and 613 are aligned, the set screw 616 is inserted through the bores 613 and 609.

Regardless which portion of the lifeline 601 is operatively connected to a drum of a self-retracting lifeline, the other portion can be easily and quickly replaced. To replace a portion of the lifeline 601, the set screw 616 is removed from the bores 609 and 613 and then the receiving member 610 is threaded off of the cylindrical portion 607. A replacement portion can then be connected to the portion of the self-retracting lifeline as described above.

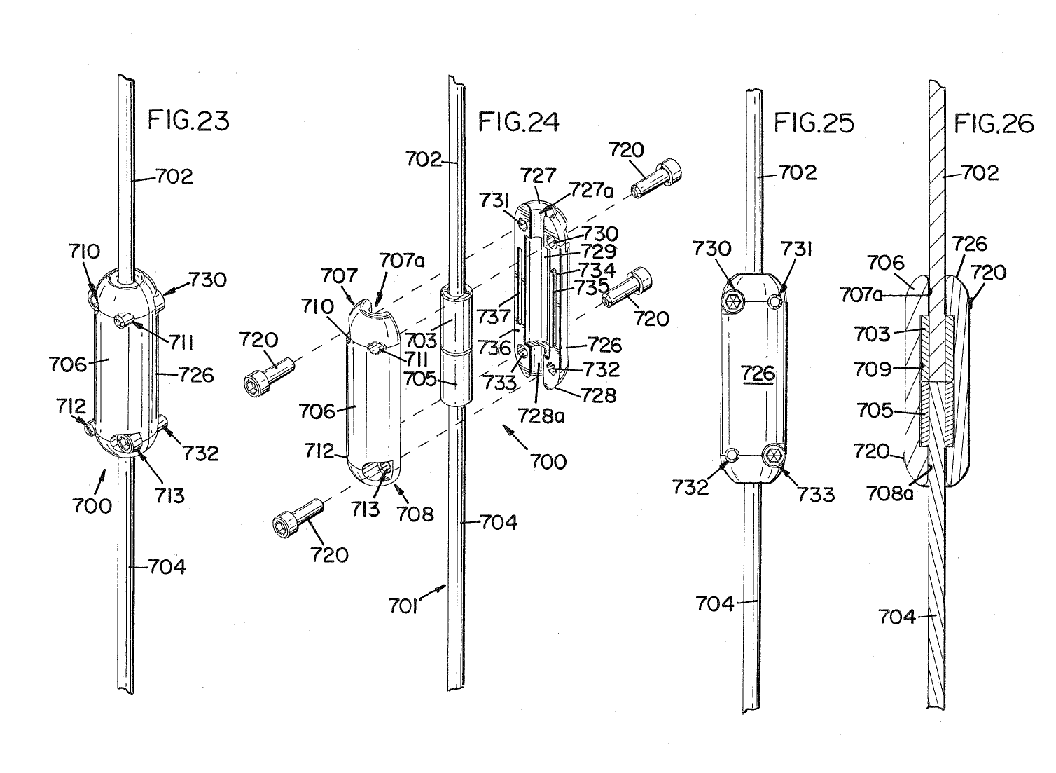

The lifeline connector 700 connects a first portion 702 and a second portion 704 of a lifeline 701. The lifeline connector 700 is shown in FIGS. 23-26. Although the lifeline 701 is shown as a cable, it is recognized that the lifeline could be a cable, a rope, webbing, or any other suitable lifeline. The first portion 702 includes a stop 703 proximate its distal end, and the second portion 704 includes a stop 705 proximate its distal end. The stops 703 and 705 are preferably cylindrical in shape, but any suitable shape could be used.

The first and second portions 702 and 704 are connected with a first housing portion 706 and a second housing portion 726, which are preferably made of metal such as steel or aluminum, however, plastic could also be used for some applications. The first and second housing portions 706 and 726 have exterior surfaces and interior surfaces, which face each other, and the first and second housing portions 706 and 726 form a generally cylindrical housing. The first and second housing portions 706 and 726 form a receiving member.

The first housing portion 706 includes a top 707 with a notch portion 707a and a bottom 708 with a notch portion 708a, and the notch portions 707a and 708a are proximate the interior surfaces. Between the notch portions 707a and 708a is a cavity 709, which is configured and arranged to receive at least a portion of the stops 703 and 705. Proximate the top 707 and the notch portion 707a an aperture 710 and a receiver 711 extend through opposing sides of the first housing portion 706. Proximate the bottom 708 and the notch portion 708a a receiver 712 and an aperture 713 extend through opposing sides of the first housing portion 706. Although not shown, a first inner side includes an extension and a second inner side includes a slot. The apertures 710 and 713 are configured and arranged to receive fasteners 720.

The second housing portion 726 includes a top 727 with a notch portion 727a and a bottom 728 with a notch portion 728a, and the notch portions 727a and 728a are proximate the interior surfaces. Between the notch portions 727a and 728a is a cavity 729, which is configured and arranged to receive at least a portion of the stops 703 and 705. Proximate the top 727 and the notch portion 727a an aperture 730 and a receiver 731 extend through opposing sides of the second housing portion 726. Proximate the bottom 728 and the notch portion 728a a receiver 732 and an aperture 733 extend through opposing sides of the second housing portion 726. A first inner side 734 includes an extension 735 and a second inner side 736 includes a slot 737. The apertures 730 and 733 are configured and arranged to receive fasteners 720.

To connect the first portion 702 and the second portion 704, the stops 703 and 705 are positioned in one of the cavities 709 and 729 so that the first and second portions 702 and 704 are positioned in the respective notch portions 707a and 708a or 727a and 728a. The other of the housing portions 706 or 726 is positioned so that the inner surfaces are facing one another and then the extension of the first housing portion 706 is placed within the slot 737 of the second housing portion 726 and the extension 735 of the second housing portion 726 is placed within the slot of the first housing portion 706. The stops 703 and 705 are then positioned within the cavities 709 and 792 and the first and second portions 702 and 704 extend through the notch portions 707a and 727a and the notch portions 708a and 728a, respectively. The fasteners 720 are then inserted through the apertures 710, 713, 730, and 733 and threaded into the respective receivers 711, 712, 731, and 732.

Regardless which portion of the lifeline 701 is operatively connected to a drum of a self-retracting lifeline, the other portion can be easily and quickly replaced. To replace a portion of the lifeline 701, the fasteners 720 are removed and the first and second housing portions 706 and 726 are disconnected so that one of the first and second portions 702 and 704 can be removed. A replacement portion can then be connected to the portion of the self-retracting lifeline as described above.

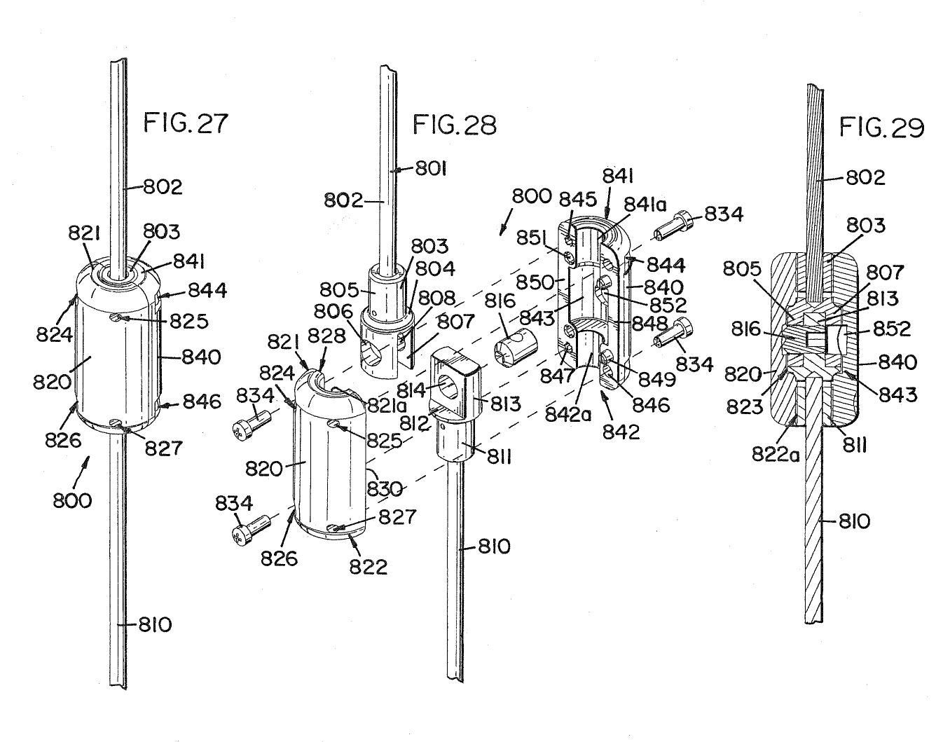

The lifeline connector 800 connects a first portion 802 and a second portion 810 of a lifeline 801. The lifeline connector 800 is shown in FIGS. 27-29. Although the lifeline 801 is shown as a cable, it is recognized that the lifeline could be a cable, a rope, webbing, or any other suitable lifeline. The first portion 802 includes a stop 803 proximate its distal end, and the second portion 810 includes a stop 811 proximate its distal end.

The stop 803 is preferably cylindrical in shape, but any suitable shape could be used. A flange 804 extends outward from the stop 803 opposite the distal end of the first portion 802, and a first extension 805 and a second extension 807 extend downward from opposing sides of the flange 804. The extensions 805 and 807 include bores 806 and 808 extending laterally through the respective extensions 805 and 807, and the bores 806 and 808 align.

The stop 811 is also preferably cylindrical in shape, but any suitable shape could be used. A flange 812 extends outward from the stop 811 opposite the distal end of the second portion 810, and an extension 813 extends upward from proximate the middle of the flange 812. The extension 813 includes a bore 814 extending laterally therethrough. The extension 813 is preferably generally rectangular in shape and the extensions 805 and 807 are configured and arranged to receive the extension 813 therebetween so that the bores 806, 814, and 808 align and are configured and arranged to receive a fastener such as a set screw 816. The extensions 805 and 807 form a receiving member.

The connector 800 also includes first and second housing portions 820 and 840, which assist in preventing the first and second portions 802 and 810 from becoming disconnected. The first and second housing portions 820 and 840 are preferably made of plastic. The first and second housing portions 820 and 840 have exterior surfaces and interior surfaces, which face each other, and the first and second housing portions 820 and 840 form a generally cylindrical housing or a receiving member.

The first housing portion 820 includes a top 821 with a notch portion 821a and a bottom 822 with a notch portion 822a, and the notch portions 821a and 822a are proximate the interior surfaces. Between the notch portions 821a and 822a is a cavity 823, which is configured and arranged to receive at least a portion of the extensions 805, 807 and 813. Proximate the top 821 and the notch portion 821a an aperture 824 and a receiver 825 extend through opposing sides of the first housing portion 820. Proximate the bottom 822 and the notch portion 822a an aperture 826 and a receiver 827 extend through opposing sides of the first housing portion 820. The apertures 824 and 826 are configured and arranged to receive fasteners 834. A first inner side 828 of the first housing portion 820 includes extensions (not shown) extending outward below and above the apertures 824 and 826, respectively. A second inner side 830 of the first housing portion 820 includes bores (not shown) below and above the receivers 825 and 827, respectively.

The second housing portion 840 includes a top 841 with a notch portion 841a and a bottom 842 with a notch portion 842a, and the notch portions 841a and 842a are proximate the interior surfaces. Between the notch portions 841a and 842a is a cavity 843, which is configured and arranged to receive at least a portion of the extensions 805, 807 and 813. Proximate the top 841 and the notch portion 841a an aperture 844 and a receiver 845 extend through opposing sides of the second housing portion 840. Proximate the bottom 842 and the notch portion 842a an aperture 846 and a receiver 847 extend through opposing sides of the second housing portion 840. The apertures 844 and 846 are configured and arranged to receive fasteners 834. A first inner side 848 of the second housing portion 840 includes extensions 849 extending outward below and above the apertures 844 and 846, respectively. A second inner side 850 of the second housing portion 840 includes bores 851 below and above the receivers 845 and 847, respectively. Optionally, a cavity or receptacle could be included in the housing portions 820 and 840 (shown as receptacle 852 in second housing portion 840 in FIGS. 28 and 29) to receive a portion of the set screw 816 that could potentially extend outward from either or both of the extensions 805 and 807.

To connect the first housing portion 820 and the second housing portion 840 and secure the connection between the extensions 805, 807, and 813, the extensions 805, 807, and 813 are positioned within one of the cavities 823 and 843 so that the stops 803 and 811 are positioned in the respective notch portions 821a and 822a or 841a and 842a. The other of the housing portions 820 and 840 is positioned so that the inner surfaces are facing one another and then the extensions of the first housing portion's first inner side are placed within the bores 851 of the second housing portion's second inner side 850 and the extensions 849 of the second housing portion's first inner side 828 are placed within the bores of the first housing portion's second inner side 830. The fasteners 834 are then inserted through the apertures 824, 826, 844, and 846 and threaded into the respective receivers 845, 847, 825, and 827.

Regardless which portion of the lifeline 801 is operatively connected to a drum of a self-retracting lifeline, the other portion can be easily and quickly replaced. To replace a portion of the lifeline 801, the fasteners 834 are removed and the first and second housing portions 820 and 840 are disconnected so that the extensions 805, 807, and 813 and the stops 803 and 811 can be removed from the cavities 823 and 843. The set screw 816 is then removed from the bores 806, 814, and 808 so that the extension 813 can be removed from in between the extensions 805 and 807. A replacement portion can then be connected to the portion of the self-retracting lifeline as described above.

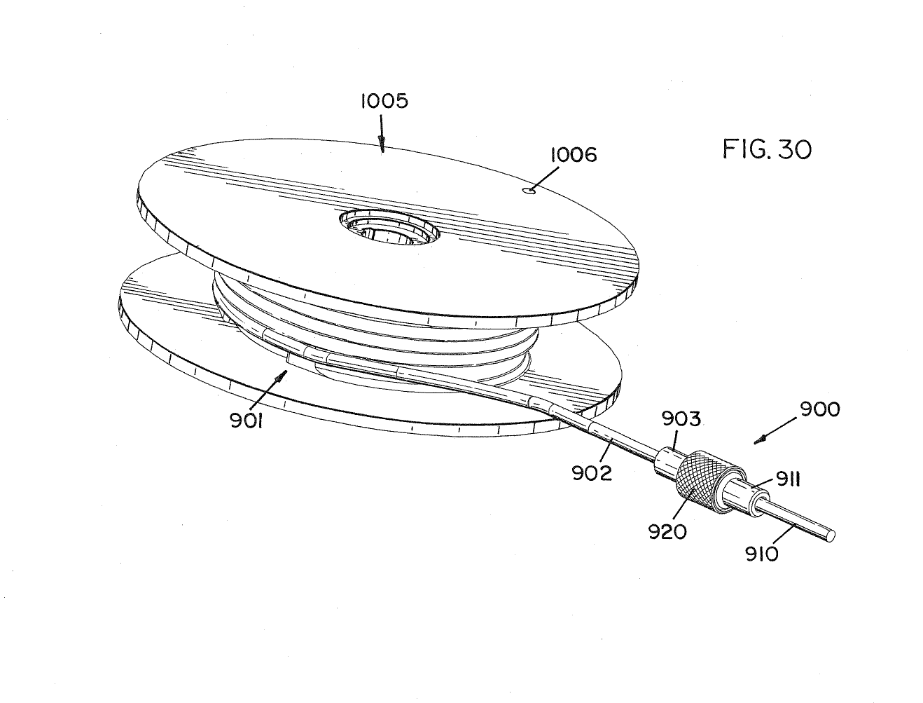

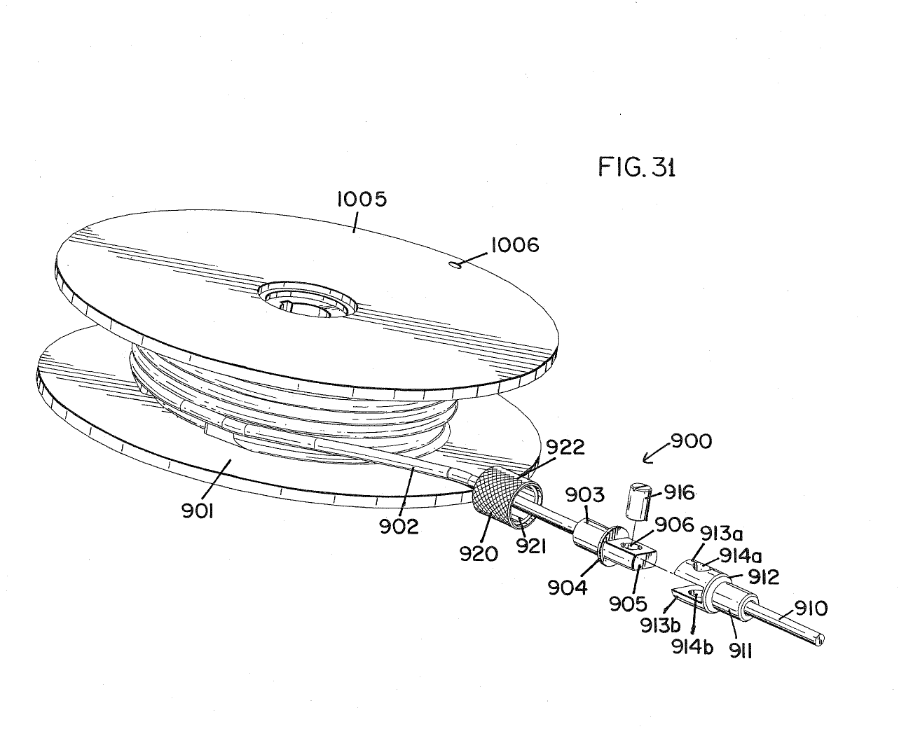

The lifeline connector 900 connects a first portion 902 and a second portion 910 of a lifeline 901. The lifeline connector 900 is shown in FIGS. 30-31. Although the lifeline 901 is shown as a cable, it is recognized that the lifeline could be a cable, a rope, webbing, or any other suitable lifeline. The first portion 902 includes a stop 903 proximate its distal end, and the second portion 910 includes a stop 911 proximate its distal end.

The stop 903 is preferably cylindrical in shape, but any suitable shape could be used. A flange 904 extends outward from the stop 903 opposite the distal end of the first portion 902, and an extension 905 extends outward from proximate the middle of the flange 904. The extension 905 includes a bore 906 extending laterally therethrough.

The stop 911 is also preferably cylindrical in shape, but any suitable shape could be used. A flange 912 extends outward from the stop 911 opposite the distal end of the second portion 910, and first and second extensions 913a and 913b extend outward from opposing sides of the flange 912. The extensions 913a and 913b include bores 914a and 914b, respectively, extending laterally through the respective extensions 913a and 913b, and the bores 914a and 914b align.

The extension 905 is preferably generally rectangular in shape and the extensions 913a and 913b are configured and arranged to receive the extension 905 therebetween so that the bores 906, 914a, and 914b align and are configured and arranged to receive a fastener such as a set screw 916. The extensions 913a and 913b form a receiving member.

The connector 900 also includes a collar portion 920 with is preferably cylindrical in shape with a bore 921 and a knurled outer surface 922. The bore 921 is at least partially threaded, and the flange 912 is also threaded to mate with the threaded bore 921. The collar portion 920 assists in keeping the extensions 905, 913a, and 913b operatively connected.

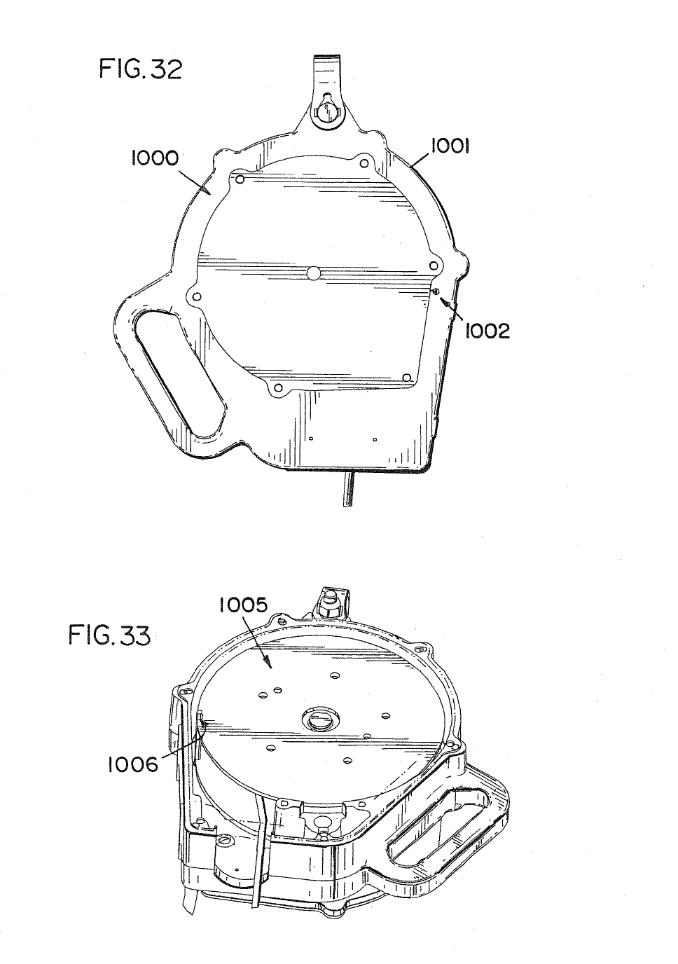

Regardless which portion of the lifeline 901 is operatively connected to a drum 1005 of a self-retracting lifeline, the other portion can be easily and quickly replaced. The drum 1005 is a simplified version of the drum 1005 shown in FIGS. 32 and 33. To replace a portion of the lifeline 901, the collar portion 920 is disconnected from the flange 912 and then the set screw 916 is removed. The extension 905 is removed from between the extensions 913a and 913b. A replacement portion can then be connected to the portion of the self-retracting lifeline as described above.

When replacing a portion of the lifeline in any of the embodiments, the lifeline is at least almost completely to completely paid out from the drum and then the tail portion of the lifeline that is operatively connected to the self-retracting lifeline's drum can be held during replacement of the other portion, a tool such as a clamp or a cleat could be used to prevent the tail portion from retracting into the housing, or the drum could be locked using a tool such as inserting an alien wrench through an aperture in the housing into an aperture of the drum as shown in FIGS. 32 and 33.

Although any suitable self-retracting lifeline could be used, an example of a suitable self-retracting lifeline 1000 is shown in FIGS. 32 and 33. The self-retracting lifeline 1000 includes a housing 1001 with an aperture 1002 and a drum 1005 with an aperture 1006. When the lifeline is at least almost completely to completely paid out from the drum, the apertures 1002 and 1006 align and a tool can be inserted through the apertures 1002 and 1006 to lock the drum.

The above specification, examples, and data provide a complete description of the manufacture and use of the composition of embodiments of the invention. Since many embodiments of the invention can be made without departing from the spirit and scope of the invention, the invention resides in the claims hereinafter appended.

We claim:

1. A lifeline connector assembly for releasably interconnecting a first portion and a second portion of a lifeline, the first portion including a first distal end to which a first stop is operatively connected, the second portion including a second distal end to which a second stop is operatively connected, comprising:
a first stop operatively connected to the first distal end;
a second stop operatively connected to the second distal end; and
a receiving member operatively connected to the second stop and configured and arranged to receive at least a portion of the first stop thereby interconnecting the first portion and the second portion.

2. The lifeline connector of claim 1, wherein the receiving member includes an aperture and a tortured pathway, the aperture providing access to the tortured pathway.

3. The lifeline connector of claim 2, wherein a portion of the first portion is routed through the tortured pathway and the aperture to connect the first and second portions, the portion extending through the aperture when connected.

4. The lifeline connector of claim 2, wherein the first stop includes an extension portion extending laterally outward from the first stop, the extension portion configured and arranged to be routed through the aperture and the tortured pathway to connect the first and second portions.

5. The lifeline connector of claim 4, wherein the receiving member includes a biasing member biasing the first stop in an upward direction when the first and second portions are connected.

6. The lifeline connector of claim 1, wherein the receiving member includes a first connector portion and a second connector portion, the first connector portion including a threaded bore and the second connector portion including a threaded cylindrical portion, the first and second connector portions configured and arranged to receive the first stop and being releasably connectable to connect the first and second portions.

7. The lifeline connector of claim 6, further comprising an extension portion including a bore extending outward from the first stop, the threaded cylindrical portion being configured and arranged to receive the extension portion and including an aperture, a fastener extending through the aperture and the bore to connect the first and second portions.

8. The lifeline connector of claim 1, wherein the second stop includes a threaded cylindrical portion extending outward therefrom, the threaded cylindrical portion including a bore, the receiving member including a threaded bore and an aperture, the receiving member being releasably connectable to the threaded cylindrical portion, wherein the bore and the aperture align and are configured and arranged to receive a fastener.

9. The lifeline connector of claim 1, wherein the receiving member includes a first connector portion and a second connector portion forming a cavity configured and arranged to receive the first and second stops, the first and second connector portions including notch portions through which the first and second portions extend when the first and second stops are operatively connected.

10. The lifeline connector of claim 9, further comprising opposing extension portions extending outward from the first stop and an extension extending outward from the second stop, the opposing extension portions configured and arranged to receive the extension, the opposing extension portions and the extension forming a bore configured and arranged to receive a fastener, wherein the receiving member is configured and arranged to receive the opposing extension portions and the extension.

11. A lifeline assembly, comprising:
a lifeline including a first lifeline portion and a second lifeline portion, the first lifeline portion including a first distal end to which a first stop is operatively connected, the second lifeline portion including a second distal end to which a second stop is operatively connected; and
a connector including a first connector portion and a second connector portion, the first connector portion and the second connector portion configured and arranged to receive and operatively connect the first stop and the second stop.

12. The lifeline assembly of claim 11, wherein the first and second connector portions each include a cavity and a notch portion, the cavities configured and arranged to receive at least a portion of the first and second stops, the notch portions configured and arranged to receive at least a portion of the lifeline.

13. The lifeline connector of claim 12, further comprising opposing extension portions extending outward from the first stop and an extension extending outward from the second stop, the opposing extension portions configured and arranged to receive the extension, the opposing extension portions and the extension forming a bore configured and arranged to receive a fastener, wherein the receiving member is configured and arranged to receive the opposing extension portions and the extension.

14. A method of replacing a portion of a lifeline, the lifeline including a first portion and a second portion releasably connectable with a connector, the first portion being operatively connected to a drum rotatable within a housing of a self-retracting lifeline, the second portion being replaceable, comprising:
paying out the lifeline to expose the connector;
disconnecting at least one of the first portion and the second portion from the connector thereby disconnecting the second portion from the first portion;
obtaining a replacement second portion; and
connecting the replacement second portion and the first portion with the connector.

15. The method of claim 14, further comprising holding the first portion while disconnecting the second portion from the first portion.

16. The method of claim 14, further comprising locking the drum to prevent rotation of the drum and winding of the lifeline about the drum during replacement of the second portion.

17. The method of claim 14, further comprising using a tool to prevent the first portion from retracting into the housing.
